(19) United States
(12) Patent Application Publication
(10) Pub. No.: US 2008/0233328 A1
(43) Pub. Date: Sep. 25, 2008

(54) INFORMATION MEDIUM

(75) Inventors: Masaki AOSHIMA, Tokyo (JP); Hiroyasu INOUE, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/038,402

(22) Filed: Feb. 27, 2008

(30) Foreign Application Priority Data
Mar. 19, 2007 (JP) 2007-069712

(51) Int. Cl. B32B 3/02

(52) U.S. Cl. 428/64.4

(57) ABSTRACT

An information medium includes a reflective layer with Ag as a main constituent, a sulfide species dielectric layer, and a recording layer in the mentioned order on a surface of a substrate. Data is recorded and reproduced by emitting a laser beam from an opposite side of the recording layer to the substrate. A barrier layer with an oxide of Zn as a main constituent is formed between the reflective layer and the sulfide species dielectric layer.

### BACKGROUND OF THE INVENTION

1. Field of the Invention

The present invention relates to an information medium constructed so that data can be recorded and reproduced by emitting a laser beam from an opposite side of a substrate to a recording layer which is formed on the substrate.

2. Description of the Related Art

As one example of this type of information medium (more specifically, an optical information recording medium), an information medium is disclosed by Japanese Laid-Open Patent Publication No. 2002-74746. This information medium has a reflective layer with Ag as a main constituent, a fourth dielectric layer (as one example, ZnS:80 mol %—SiO2:20 mol %), a third dielectric layer (as one example, GeN), a recording layer (GeSbTe system), a second dielectric layer (as one example, GeN), a first dielectric layer(ZnS:80 mol %—SiO2:20 mol %), and a protective layer (polycarbonate) laminated in the mentioned order on a substrate (polycarbonate), and is an optical information recording medium where laser light is incident from the protective layer-side and a barrier layer is provided between the reflective layer and the fourth dielectric layer. A GeCrN layer or a layer of Sn, In, Zr, Si, Cr, Al, Ta, V, Nb, Mo, W, Ti, Mg, or Ge or a nitride, oxide, oxynitride, or carbide with the listed elements as a main constituent is used as the barrier layer. For this kind of information medium, by providing the barrier layer described above between the reflective layer and the fourth dielectric layer, corrosion of the Ag in the reflective layer due to the S included in the fourth dielectric layer is avoided, thereby improving reliability.

### SUMMARY OF THE INVENTION

Although a variety of elements that can be used as the barrier layer are disclosed in the publication mentioned above, the inventors of the present invention have conducted research into the use of other elements in the barrier layer in order to further prevent corrosion of the Ag in the reflective layer and thereby achieve an information medium with even higher reliability. By doing so, the present inventors found a more favorable element for the barrier layer.

The present invention was conceived in view of the problem described above and it is a principal object of the present invention to provide an information medium with higher reliability.

To achieve the stated object, an information medium according to the present invention includes: a reflective layer with Ag as a main constituent; a sulfide species dielectric layer, and a recording layer, formed in the mentioned order on a surface of a substrate, wherein data is recorded and reproduced by emitting a laser beam from an opposite side of the substrate to the recording layer, and a barrier layer with an oxide of Zn as a main constituent is formed between the reflective layer and the sulfide species dielectric layer. Note that the expression “main constituent” for the present invention refers to a constituent with the largest proportion (mol %) out of a plurality of compounds, such as oxides and sulfides, that construct the material forming a film or layer.

With the information medium according to the present invention, by forming the barrier layer with an oxide of Zn as the main constituent between the reflective layer and the sulfide species dielectric layer that includes sulfur (S), it is possible to reliably avoid corrosion of the Ag that constructs the reflective layer due to the sulfide (more specifically, S) included in the sulfide species dielectric layer for a long period, thereby making it possible to provide an information medium with higher reliability.

On the information medium according to the present invention, the barrier layer may be formed in contact with the reflective layer.

With this construction, it is possible to sufficiently improve the adhesion of the barrier layer to the reflective layer.

It should be noted that the disclosure of the present invention relates to a content of Japanese Patent Application 2007-069712 that was filed on 19 Mar. 2007 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view showing the construction of an information medium according to an embodiment of the present invention; and

FIG. 2 is a table showing results of observing corrosion for various examples and comparative examples.

### DESCRIPTION OF THE PREFERRED EMBODIMENTS

Preferred embodiments of an information medium according to the present invention will now be described with reference to the attached drawings.

First, the construction of an information medium 1 will be described with reference to the drawings.

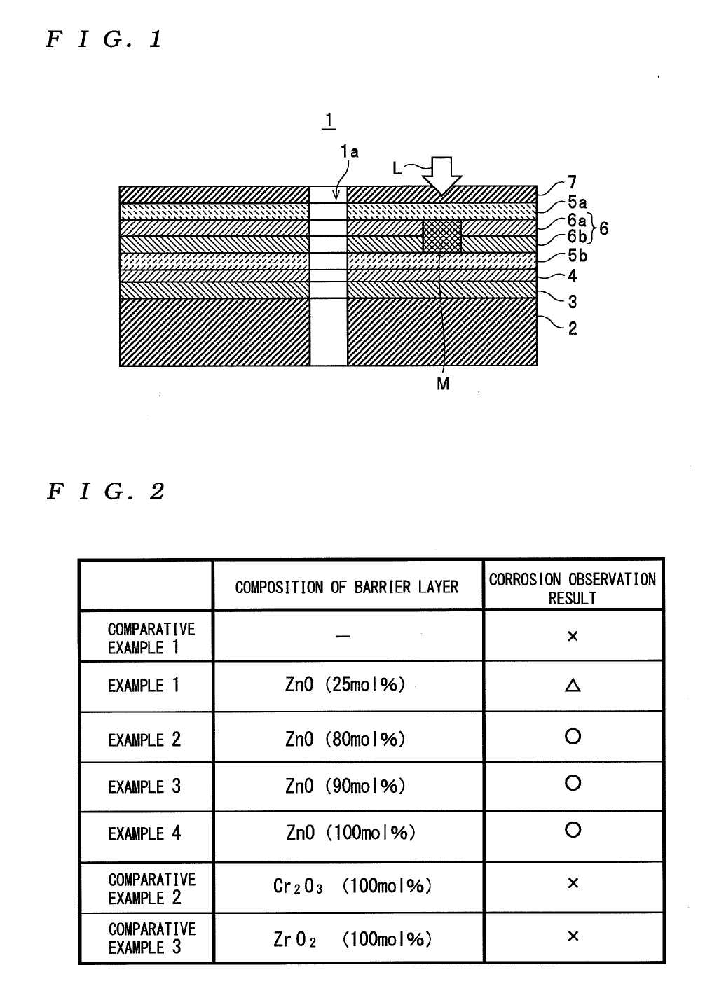

The information medium 1 is a single-sided, single-layer, write-once optical disc that is formed in a circular plate shape with an external diameter of around 120 mm and a thickness of around 1.2 mm. The information medium 1 is constructed so that data can be recorded and reproduced using a blue-violet laser beam (hereinafter simply “laser beam”) L with a wavelength (A) in a range of 380 nm to 450 nm, inclusive (as one example, 405 nm) emitted from an objective lens with a numerical aperture (NA) of at least 0.7 (as one example, around 0.85). More specifically, as shown in FIG. 1, the information medium 1 is constructed by laminating a reflective layer 3, a barrier layer 4, a second dielectric layer 5b, a recording layer 6, a first dielectric layer 5a, and a light transmitting layer 7 in the mentioned order on a substrate 2. An attachment center hole 1a for attaching (clamping) the information medium 1 to a recording/reproducing apparatus is formed in the center of the information medium 1. Note that for ease of understanding, the thickness of the information medium 1 has been exaggerated in the drawing.

The substrate 2 is formed in a circular plate shape with a thickness of around 1.1 mm by injection molding polycarbonate resin, for example. The substrate 2 can alternatively be formed by various other methods, such as by using a photopolymer (“2P”). On one surface of the substrate 2 (the upper surface in FIG. 1), grooves and lands (neither is shown) are formed in a spiral from the center toward the outer edge. The grooves and lands function as guide tracks when recording and reproducing data on the recording layer 6. As one example, the depth of the grooves is set in a range of 10 nm to 40 nm, inclusive, and the pitch of the grooves is set in a range of 0.2 μm to 0.4 μm, inclusive. As shown in FIG. 1, the information medium 1 is constructed with a premise of the laser beam L being emitted from the light transmitting layer 7-side during recording and reproducing. Since the substrate 2 does not need to transmit light, the material used to form the substrate 2 is not limited to the polycarbonate resin mentioned above and it is possible to use various resin materials (such as olefin resin, acrylic resin, epoxy resin, polystyrene resin, polyethylene resin, polypropylene resin, silicone resin, fluorine resin, ABS resin, and urethane resin), or other materials such as glass and ceramics. However, it is preferable to use a resin material such as polycarbonate resin or olefin resin since resin is easy to mold and comparatively inexpensive.

The reflective layer 3 is provided to reflect the laser beam L emitted from the light transmitting layer 7-side during the reproducing of data and is formed of an Ag material (as one example, only Ag) to achieve high reflectivity and high thermal conductivity. To improve the corrosion resistance of the reflective layer 3, it is preferable to use an alloy with Ag as a main constituent and Pd, Cu, Nd, Ta, or the like as an additive (as examples, AgNdCu=98:1:1 and AgPdCu=98:1:1). The reflective layer 3 is formed with a thickness in a range of 10 nm to 300 nm, inclusive. To achieve a required and sufficient reflectivity for the laser beam L, the thickness of the reflective layer 3 should preferably be set in a range of 20 nm to 200 nm, inclusive and more preferably in a range of 40 nm to 100 nm, inclusive (as one example, 80 nm).

The barrier layer 4 is provided to avoid corrosion of the Ag that forms the reflective layer 3 due to S, described later, included in the second dielectric layer 5b and is formed of a material with an oxide of Zn (one example, ZnO in the present embodiment) as a main constituent. The barrier layer 4 is provided between the reflective layer 3 and the second dielectric layer 5b and contacts the reflective layer 3. By using an oxide of Zn in the barrier layer 4, it is possible to avoid corrosion of the Ag that constructs the reflective layer 3 due to the S in the second dielectric layer 5b for a longer period than with a barrier layer disclosed in the related art. A construction where an intermediate layer is provided between the barrier layer 4 and the reflective layer 3 is also conceivable and it is thought that such construction would also be able to sufficiently prevent corrosion of the Ag. However, since an oxide of Zn has favorable adhesion to Ag when sputtered on the reflective layer 3 composed of Ag, to prevent delamination, it is preferable to form the barrier layer 4 directly on the surface of the reflective layer 3 without an intermediate layer being formed. When the barrier layer 4 is formed of an oxide of Zn, there is also sufficient adhesion to the second dielectric layer 5b. The barrier layer 4 is formed so as to include at least 25 mol % of ZnO with a thickness in a range of 3 nm to 30 nm, inclusive (as one example, 5 nm in the present embodiment). The thickness range mentioned above is preferable since when the thickness of the barrier layer 4 is below 3 nm, it is not possible to sufficiently prevent corrosion of the Ag, while when the thickness of the barrier layer 4 is above 30 nm, there is a risk of cracking due to internal stress. To achieve the desired optical characteristics and thermal conductivity characteristics, and/or to facilitate the fabrication of a vapor-phase growth matrix (as one example, a sputtering target material), as the non-ZnO component of the barrier layer 4, it is possible to add compounds aside from metal sulfides, such as metal oxides or metal nitrides, in a range that does not depart from the scope of the present invention.

The first dielectric layer 5a and the second dielectric layer 5b (hereinafter referred to as the “dielectric layers 5” when no distinction is required) are formed so as to sandwich the recording layer 6. The dielectric layers 5 prevent deterioration of data by preventing (reducing) corrosion of the recording layer 6 and also prevent thermal deformation of the substrate 2 and the light transmitting layer 7 during the recording of data, which makes it possible to avoid increases in jitter. The dielectric layers 5 also function so as to increase the change in optical characteristics between recorded parts (parts where pits are formed in the recording layer) and non-recorded parts (parts where pits have not been formed) due to multiple interference. To enhance such change, it is preferable to form the dielectric layers 5 of a dielectric material with a high refractive index (n) for the wavelength range of the laser beam L. When the laser beam L is emitted, if an excessive amount of energy is absorbed by the dielectric layers 5, there will be a drop in the recording sensitivity of the recording layer 6. It is preferable to avoid such a drop in recording sensitivity by constructing the dielectric layers 5 of a dielectric material with a low extinction coefficient (k) for the wavelength range of the laser beam L.

More specifically, as the dielectric material for forming the dielectric layers 5, from the viewpoint of achieving all of the functions of the dielectric layers 5 described above, a dielectric material that includes a sulfide (a “sulfide species dielectric material”) is used, and therefore out of the dielectric layers 5, the second dielectric layer 5b is composed of a “sulfide species dielectric material layer” for the present invention. A “sulfide species dielectric material layer” is a material that includes S and transmits light, with it being possible to select arbitrary metal oxides and/or metal sulfides to achieve the desired optical characteristics. It is possible to form both the first dielectric layer 5a and the second dielectric layer 5b from the same dielectric material or from different dielectric materials. It is also possible to form one or both of the first dielectric layer 5a and the second dielectric layer 5b with a multilayer construction composed of a plurality of dielectric layers.

In the present embodiment, the first dielectric layer 5a and the second dielectric layer 5b are formed with a thickness in a range of 10 nm to 200 nm, inclusive (as one example, 30 nm) from a mixture of ZnS and SiO₂ (preferably with a mole ratio of 80:20). Here, since a mixture of ZnS and SiO₂ has a high refractive index (n) and a comparatively low extinction coefficient (k) for a laser beam L with a wavelength in a range of 380 nm to 450 nm, inclusive, it is possible to make the changes in the optical characteristics of the recording layer 6 before and after the recording of data more prominent, and to avoid a drop in the recording sensitivity. The respective thicknesses of the first dielectric layer 5a and the second dielectric layer 5b are not limited to the examples described above, but when the thicknesses are below 10 nm, it is difficult to achieve the effects described above. On the other hand, when the dielectric layers 5 are over 200 nm thick, the time required to form the layers will increase, resulting in a risk of an increase in the manufacturing cost of the information medium 1 and also the risk of cracking appearing in the information medium 1 due to internal stresses in the first dielectric layer 5a and/or the second dielectric layer 5b. Accordingly, the thicknesses of both dielectric layers 5a, 5b should preferably be set in a range of 10 nm to 200 nm, inclusive.

The recording layer 6 is a layer in which recording parts M (pits) are formed due to the optical characteristics of the recording layer 6 changing when the laser beam L is emitted during the recording of data. As one example, the recording layer 6 is constructed by forming two thin films, a second sub-recording film 6b and a first sub-recording film 6a, in the mentioned order on the second dielectric layer 5b. The first sub-recording film 6a is formed as a thin film of a material with Si as a main constituent and the second sub-recording film 6b is formed as a thin film of a material with Cu as a main constituent. By constructing the recording layer 6 of the first sub-recording film 6a and the second sub-recording film 6b in the mentioned order from the light transmitting layer 7-side (i.e., from the side on which the laser beam L is incident), it becomes possible for the optical characteristics to sufficiently change even when the laser beam L has comparatively low power. This means that the recording parts M can be reliably formed.

Here, the greater the thickness of the first sub-recording film 6a and the thickness of the second sub-recording film 6b (i.e., the total thickness of the recording layer 6), the larger the drop in the surface smoothness of the first sub-recording film 6a that is closer to the surface on which the laser beam L is incident, the higher the noise level in a reproducing signal, and the lower the recording sensitivity. Accordingly, to avoid such problems, the total thickness of the recording layer 6 is set in a range of 2 nm to 50 nm, inclusive. For the optical characteristics to sufficiently change before and after the recording of data, the thicknesses of the first sub-recording film 6a and the second sub-recording film 6b are set so that the ratio of the thicknesses (i.e., the thickness of the first sub-recording film 6a/the thickness of the second sub-recording film 6b) is in a range of 0.2 to 5.0, inclusive. In the present embodiment, as one example, the thickness of the second sub-recording film 6b is set at 5 nm and the thickness of the first sub-recording film 6a is set at 5 nm. Note that the recording layer 6 is not limited to the construction described above and can alternatively be constructed of a single layer. The recording layer 6 is also not limited to a write-once layer and may be a rewritable recording film.

The light transmitting layer 7 functions as an optical path of the laser beam L during recording and reproducing of data and also physically protects the recording layer 6 and the first dielectric layer 5a. The light transmitting layer 7 is formed of a resin material, such as a UV-curable resin or an electron beam curable resin, with a thickness in a range of 1 μm to 200 μm, inclusive (preferably, a thickness in a range of 50 μm to 150 μm, inclusive: as one example, 100 μm). Note that a number of methods can be used as the method of forming the light transmitting layer 7, such as a method of applying a resin material by spin coating or the like and then curing the resin material and a method of sticking a sheet formed of light-transmitting resin onto the first dielectric layer 5a using adhesive or the like. In the present embodiment, to avoid attenuation of the laser beam L, spin coating is used since no layer of adhesive is formed.

When manufacturing the information medium 1, first a stamper for molding a substrate is set on a mold placed in an injection molding machine. After this, the substrate 2 is injection molded with the temperature of the polycarbonate resin set at around 360° C., the mold temperature set at around 120° C., and various other molding conditions such as the mold clamping force and cooling time set as appropriate. Next, the reflective layer 3 is formed with a thickness of around 80 nm on the surface of the substrate 2 by vapor-phase growth (such as vacuum deposition or sputtering, in this example sputtering) using a chemical species with Ag as a main constituent, for example. After this, the barrier layer 4 is formed with a thickness of around 5 nm on the surface of the reflective layer 3 by vapor-phase growth (as one example, sputtering) using a chemical species with ZnO as a main constituent.

After this, the second dielectric layer 5b is formed with a thickness of around 30 nm by vapor-phase growth using a chemical species with a mixture of ZnS and SiO₂ as a main constituent so as to cover the barrier layer 4. Next, the second sub-recording film 6b is formed with a thickness of around 5 nm by vapor-phase growth using a material (chemical species) with Cu as a main constituent so as to cover the second dielectric layer 5b.

Next, the first sub-recording film 6a is formed with a thickness of around 5 nm by vapor-phase growth using a material (chemical species) with Si as a main constituent so as to cover the second sub-recording film 6b. When doing so, since the second sub-recording film 6b is formed with a smooth surface, the surface of the first sub-recording film 6a is also formed smooth. After this, the first dielectric layer 5a is formed with a thickness of around 30 nm by vapor-phase growth using a chemical species with a mixture of ZnS and SiO₂ as a main constituent so as to cover the first sub-recording film 6a. Note that the reflective layer 3, the barrier layer 4, the second dielectric layer 5b, the second sub-recording film 6b, the first sub-recording film 6a, and the first dielectric layer 5a should preferably be consecutively formed on the substrate 2 by appropriately adjusting deposition conditions in each chamber of a sputtering machine with a plurality of sputtering chambers. After this, by applying an acrylic UV-curable resin (or an epoxy UV-curable resin), for example, by spin coating so as to cover the first dielectric layer 5a and curing the resin, the light transmitting layer 7 is formed with a thickness of around 100 μm on the first dielectric layer 5a. By doing so, the information medium 1 is completed.

With this information medium 1, data can be recorded and reproduced by a recording/reproducing apparatus capable of emitting the laser beam L with a wavelength (λ) of 405 nm from an objective lens with a numerical aperture (NA) of 0.85, for example.

In this way, according to the information medium 1, by forming the barrier layer 4 with an oxide of Zn as the main constituent between the reflective layer 3 and the second dielectric layer 5b that includes S, it is possible to reliably avoid corrosion of the Ag that constructs the reflective layer 3 due to the sulfide (more specifically, S) included in the second dielectric layer 5b for a long period, thereby making it possible to provide an information medium with higher reliability. Also, according to the information medium 1, by forming the barrier layer 4 in contact with the reflective layer 3, it is possible to sufficiently improve the adhesion of the barrier layer 4 to the reflective layer 3 (that is, it is possible to make the information medium 1 resistant to delamination).

### EXAMPLES

Next, the information medium 1 according to the present invention will be described in detail with reference to examples.

### Examples 1 to 4

Samples of information media were fabricated as Examples 1 to 4 according to the method of manufacturing described above with the construction shown in FIG. 1 and the amounts of ZnO shown in FIG. 2 in the barrier layer 4.

### Comparative Example 1

Samples of information media as Comparative Example 1 were fabricated by forming the second dielectric layer 5b directly on the surface of the reflective layer 3 without the barrier layer 4 being formed in the method of manufacturing described above.

### Comparative Example 2

Samples of information media as Comparative Example 2 were fabricated by forming the barrier layer 4 using a chemical species composed of Cr₂O₃ in place of a chemical species with ZnO as a main constituent in the method of manufacturing described above.

### Comparative Example 3

Samples of information media as Comparative Example 3 were fabricated by forming the barrier layer 4 using a chemical species composed of ZrO₂ in place of a chemical species with ZnO as a main constituent in the method of manufacturing described above.

Evaluating the Information Media

Storage environment tests were carried out for 450 hours in a high-temperature, high-humidity environment of 70° C. and 90% RH on the samples of the respective information media and corrosion of the reflective layer 3 was observed using an optical microscope. The observation results of such tests are shown together with the type and composition of the respective barrier layers in FIG. 2. Corrosion of the reflective layer 3 was observed for comparative example 1 that has no barrier layer and for Comparative Examples 2 and 3 where a barrier layer is present but such barrier layer is composed of Cr₂O₃ or ZrO₂. On the other hand, corrosion of the reflective layer 3 was not observed for Examples 2 to 4 that include a barrier layer with at least 80 mol % of ZnO as a main constituent. Note that although an extremely small amount of corrosion was observed for Example 1 that includes a barrier layer with 25 mol % of ZnO as a main constituent, such corrosion is not problematic in actual use and such media are judged to be non-defective.

In this way, for the information medium 1 according to the present invention that includes the barrier layer 4 with ZnO as a main constituent, it was confirmed that corrosion of the reflective layer 3 can be prevented more effectively, even during storage environment tests such as those described above. On the other hand, for information media that include barrier layers made of an oxide of Zr and an oxide of Cr that are included in the elements disclosed by the related art as elements used in the barrier layer, corrosion of the reflective layer 3 was observed in weather resistance tests according to the conditions described above. Accordingly, it was confirmed that by providing the barrier layer 4 with ZnO as the main constituent, it is possible to realize an information medium with higher reliability.

Note that although an example where a blue-violet laser beam L with a wavelength (λ) in a range of 380 nm to 450 nm, inclusive (as one example, 405 nm) is used during recording and reproducing of data has been described above in the embodiment of the present invention, the wavelength of the laser beam used on the information medium according to the present invention is not limited to this and it is possible to construct the information medium so as to be capable of recording and reproducing data using various types of laser beams with a wavelength (λ) in a range of 250 nm to 900 nm, inclusive. In addition, the thicknesses of the various layers that have been described in the embodiment of the present invention are merely examples to which the present invention is not limited, and such thicknesses can obviously be changed as appropriate. Also the present invention is not limited to a write-once recording film and can be applied to a phase-change (i.e., rewritable) recording film.

What is claimed is:

1. An information medium comprising:
a reflective layer with Ag as a main constituent;
a sulfide species dielectric layer; and
a recording layer,
formed in the mentioned order on a surface of a substrate,
wherein data is recorded and reproduced by emitting a laser beam from an opposite side of the substrate to the recording layer, and
a barrier layer with an oxide of Zn as a main constituent is formed between the reflective layer and the sulfide species dielectric layer.

2. An information medium according to claim 1, wherein the barrier layer is formed in contact with the reflective layer.
